(19) United States
(12) Patent Application Publication
(10) Pub. No.: US 2024/0418619 A1
(43) Pub. Date: Dec. 19, 2024

(54) POLARIMETRIC LIGHT FIELD IMAGING SYSTEM FOR AN AEROSOL PLUME

(71) Applicant: ACME Atronomatic, LLC, Orlando, FL (US)

(72) Inventor: Sarvesh GARIMELLA, Portland, OR (US)

(21) Appl. No.: 18/741,961

(22) Filed: Jun. 13, 2024

Related U.S. Application Data
(60) Provisional application No. 63/472,639, filed on Jun. 13, 2023.

(51) Int. Cl. G01N 15/0205; G01N 15/075; G06T 7/00

(52) U.S. Cl. CPC G01N 15/0211; G01N 15/075; G06T 7/0002; G06T 2207/10048; G06T 2207/20081; G06T 2207/20084

(57) ABSTRACT

A polarimetric light field imaging system for an aerosol plume may include laser sources operating at different wavelengths and configured to generate a plurality of laser beams. The system may also include an optical arrangement downstream from the laser sources that is configured to transmit the laser beams toward the aerosol plume and receive backscatter images therefrom. A spectral polarization filter may be downstream from the optical arrangement, and a light field sensor may be downstream from the spectral polarization filter that is configured to capture a plurality of backscatter images of the aerosol plume at different polarizations. In addition, the system may include a processor coupled to the light field image sensor and may be configured to use a Machine Learning (ML) model to determine a particle density and a particle size distribution of the aerosol plume.

### RELATED APPLICATIONS

This application claims priority to U.S. Provisional Application Ser. No. 63/472,639 filed on Jun. 13, 2023, the contents of which are herein incorporated by reference in their entirety.

### TECHNICAL FIELD

The present invention relates to standoff characterization technology, and, more particularly, to a polarimetric light field imaging system for an aerosol plume and associated methods.

### BACKGROUND

The ability to accurately measure and quantify aerosol plume density and particle size distribution may be essential for assessing potential exposure risks and environmental propagation of hazardous materials, especially in cases of inadvertent releases during the destruction of threat chemical and biological facilities. However, existing standoff ground-based optical systems may lack the capacity to provide comprehensive aerosol characterization, specifically the measurement of particle size distribution. The accurate characterization of standoff targets, including aerosol plumes with variable and uncertain particle concentrations and particle size distribution, may be critical for various applications such as environmental monitoring, climate studies, and threat assessment.

Traditional methods for aerosol quantification, such as hyperspectral imaging and single-color Light Detection and Ranging (LIDAR), are typically equipped to evaluate plume densities, but may have limited efficacy when it comes to particle size distribution. Potentially key among these limitations is the inability of existing techniques to account effectively for the impacts that multiple scattering and limited angular resolution have on the returned signal. In-situ sampling techniques are currently available for accurately quantifying aerosol plume parameters, but utilizing point sensors within the plume may be impractical and unfeasible in most operational environments. These gaps in current methodologies underscore the urgent need for a more effective, standoff ground-based optical system.

### SUMMARY

A polarimetric light field imaging system for an aerosol plume may include a plurality of laser sources operating at different wavelengths and configured to generate a plurality of laser beams. An optical arrangement downstream from the plurality of laser sources is configured to transmit the plurality of laser beams toward the aerosol plume and receive backscatter images therefrom. The system may also include a spectral polarization filter downstream from the optical arrangement, and a light field sensor downstream from the spectral polarization filter that is configured to capture a plurality of backscatter images of the aerosol plume at different polarizations. In addition, the system may include a processor coupled to the light field image sensor that is configured to use a Machine Learning (ML) model to determine a particle density and a particle size distribution of the aerosol plume.

The processor may be configured to use the ML model based upon a plurality of training backscatter images, and the ML model may comprise a convolutional neural network (CNN), a random forest, or a deep artificial neural network, for example. The processor may be configured to control the spectral polarization for co-polarized and cross-polarized backscatter images. The spectral polarization filter may comprise a rotatable spectral polarization filter.

The light field sensor may be configured to perform hyperspectral wavelength discrimination, i.e. to perform measurements of both angular independence and wavelength shift of backscatter images. The plurality of laser sources may include a near infrared laser source and a shortwave infrared laser source, for example.

In another aspect, a method of polarimetric light field imaging may include operating a plurality of laser sources at different wavelengths to generate a plurality of laser beams, transmitting the plurality of laser beams toward the aerosol plume using an optical arrangement downstream from the plurality of laser sources, and capturing a plurality of backscatter images of the aerosol plume at different polarizations using a light field sensor downstream from a spectral polarization filter. The method may also include determining a particle density and a particle size distribution of the aerosol plume using a Machine Learning (ML) model, such as based upon a plurality of training backscatter images, for example. The method may also include performing measurements of both angular independence and wavelength shift of backscatter images using the light field sensor.

### BRIEF DESCRIPTION OF THE DRAWINGS

FIG. 1 is a schematic illustrating a light field detector operating principle;

FIG. 2 is a schematic of a polarimetric light field imaging system in accordance with a particular embodiment of the invention;

FIG. 3 is a block diagram of the system in which various aspects of the disclosure may be implemented; and

FIG. 4 is a flowchart of a method of polarimetric light field imaging.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Light field technology is an advanced imaging technique that captures not only the intensity of light rays in a scene but also their direction. This approach provides a more comprehensive representation of light in the environment, allowing for various applications and enhanced image manipulation.

Traditional cameras capture light intensity at each pixel, which represents a 2D image. Light field cameras, on the other hand, capture the intensity and direction of light rays, creating a 4D dataset.

The most common implementation of light field technology is the plenoptic camera. These cameras have an array of microlenses positioned between the main lens and the image sensor. Each microlens captures light from different angles, recording the direction and intensity of incoming light rays. The captured light field data may use computational algorithms to process and render the final images. This data can be manipulated post-capture to change focus, perspective, and depth of field. Overall, light field technology represents a significant advancement in imaging, providing new capabilities and enhancing the quality and interactivity of captured images.

Backscatter refers to the phenomenon where particles, waves, or signals are scattered back in the direction from which they came. This concept is used in various fields, including physics, telecommunications, radar, and medical imaging, each with specific implications and applications. When particles, waves, or signals encounter an obstacle or a different medium, they can be deflected in various directions. Backscatter specifically refers to the portion of these scattered particles, waves, or signals that are redirected back toward the source. A backscatter coefficient is a measure of the fraction of the incident energy that is scattered back toward the source. It depends on the properties of the scattering medium and the wavelength of the incident waves.

In LIDAR systems, laser pulses are emitted and the backscattered light is detected to map out distances and create detailed 3D models of the environment. The wavelength of the incident wave affects the amount of backscatter. Different wavelengths interact differently with various materials and particle sizes. In addition, the composition, size, shape, and surface roughness of the scattering medium influence the backscatter intensity. The angle at which waves strike the scattering medium also affects the backscattered signals. Some angles might produce stronger backscatter depending on the medium's properties. Backscatter is crucial for detecting and analyzing objects or phenomena that are not directly visible.

An objective of the present embodiments is a polarimetric light field imaging system that captures co- and cross-polarized backscattered ray field information, including both photon intensity and direction, at multiple wavelengths. By comparing the rich datasets generated from spectral light field backscatter measurements to ground-truth instrument data, empirical mappings are constructed using machine learning (ML) that utilizes the multi-scattering and particle aerosol shape information contained in the polarized spectral light field data. Utilizing multiple wavelengths can improve LIDAR systems to differentiate types of aerosol, especially at longer wavelengths. Also, the use of co- and cross-polarized backscatter reveals information about particle shape and composition. Combining these principles in the system uses light field technology both to improve angular resolution of backscatter signal as well as to treat the effects of multiple scattering more explicitly.

Hyperspectral wavelength refers to the specific bands of the electromagnetic spectrum that are captured and analyzed in hyperspectral imaging. Hyperspectral imaging (HSI) is a technique that collects and processes information across a wide range of wavelengths. Unlike traditional imaging, which captures images in three primary color bands (red, green, and blue), or multispectral imaging, which captures images in a limited number of bands, hyperspectral imaging acquires data in numerous narrow and contiguous spectral bands across a wide spectrum.

Hyperspectral imaging typically covers a wide range of wavelengths. Commonly, the ranges include the visible spectrum of wavelengths of approximately 400-700 nanometers (nm), near-infrared (NIR) of wavelengths of approximately 700-1,000 nm, short-wave infrared (SWIR) of wavelengths of approximately 1,000-2,500 nm, mid-wave infrared (MWIR) of wavelengths of approximately 3,000-5,000 nm, and long-wave infrared (LWIR) of wavelengths of approximately 8,000-14,000 nm. In summary, hyperspectral wavelengths refer to the specific narrow and contiguous spectral bands used in hyperspectral imaging.

Light field detectors employ an array of micro lenses at the imaging sensor to measure the vector direction information in addition to the intensity of the incoming light field. This allows them to be used to reconstruct 3D images and perform post-capture focus. Modern advances in commercial light field cameras have also introduced multi- and hyperspectral capabilities, allowing analysis of spectral signatures across a range of wavelengths.

The present embodiments provide a standoff target characterization system that leverages the capabilities of polarimetry, light field imaging, multiple laser sources, and machine learning. The system is designed to efficiently and accurately analyze spectral polarimetric light field data from various targets including aerosol plumes.

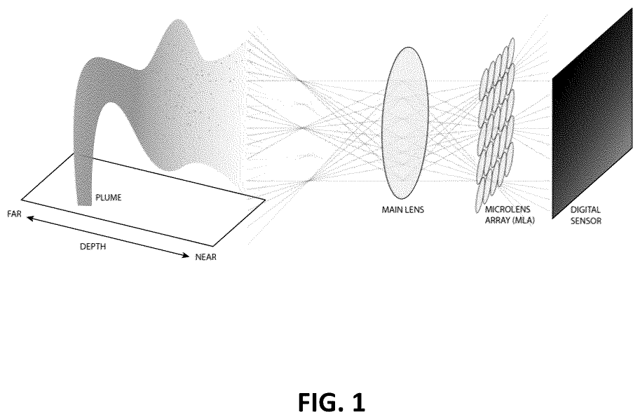

Referring now to FIG. 1, a schematic of a light field detector 100 operating principle is now described. The direction of a laser light 105 and position of the laser light 105 as it enters the main lens 102 are both captured by the light field sensor 106 as a feature of the microlens array (MLA) 104, allowing for characterization of the angular dependence of backscatter signal from an aerosol plume 108, for example.

When illuminating the aerosol plume 108, some of the laser light will be backscattered to the exit optics and will follow the straight-line return path to the light field sensor 106. The return laser light will pass through a polarizer that may be manually or automatically set to transmit either co-polarized or cross-polarized light, and the alternating between these detection polarizations captures both the co- and cross-polarized 3D light fields backscattered from the target aerosol plume.

Any deviations from pure co-polarized and columnated backscatter generates information about multiple scattering, and the properties of the light field sensor 106 measures angular dependence in the backscattered light across the diameter of the exit optics aperture. This additional information beyond total backscatter will contain information about the shape and composition of the target scatters, which the ML retrievals utilize when learning how to statistically constrain the aerosol plume density and size distribution.

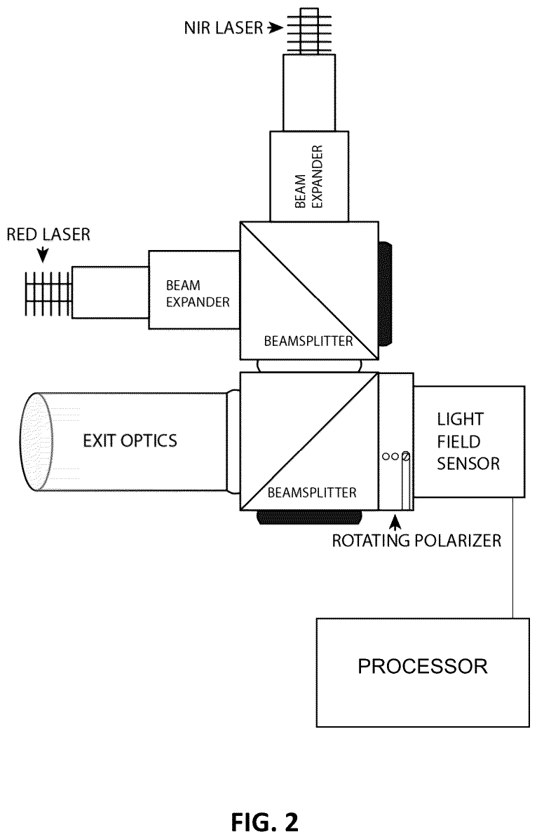

Referring now to FIG. 2, a schematic of a polarimetric light field imaging system for an aerosol plume is depicted and generally designated 110. The system 110 includes as aerosol light-field polarimetric spectrometer (ALPS) 105. The ALPS 105 includes a light field sensor 106 such as a hyperspectral light field camera to perform aerosol measurements and a plurality of laser sources 112, 114 operating at different wavelengths and configured to generate a plurality of laser beams. The plurality of laser sources 112, 114 may include a near infrared laser source and a shortwave infrared laser source. For example, one laser source may operate at 640 nm and the other at 785 nm, with their corresponding drivers and power supplies utilized as the polarized light emission sources for the system 110. The laser beams will be expanded 116a, 116b and directed via non-polarizing beam splitting optics 118a, 118b to illuminate the visible target area through an optical arrangement such as telescopic exit optics 120.

The optical arrangement 120 downstream from the plurality of laser sources 112, 114 is configured to transmit the plurality of laser beams toward the aerosol plume and receive backscatter images therefrom.

Backscattered light from the lasers 112, 114 returns to the light field sensor 106 through the exit optics 120 and a rotatable polarizer 122. A processor 124 analyzes the output of the light field sensor 106 to determine target characteristics, such as aerosol plume density and particle size distribution.

The light field sensor 106 is preferably capable of hyperspectral wavelength discrimination and permits measurement of both angular independence and wavelength shift of backscattered light across a diameter of the exit optics 120. Used with the rotatable polarizer 122, the light field sensor 106 can alternately capture images of co-polarized and cross-polarized backscatter, allowing collection of significant additional information beyond total backscatter. This includes information on different types of scattering interactions.

The processor 124 analyzes the data from the light field sensor 106 to characterize the target and determining characteristics such as aerosol plume density and particle size distribution. Advantageously, the processor 124 employs advanced machine learning (ML) algorithms, such as deep neural networks (e.g., the U-Net convolutional neural network), to statistically constrain data output.

The processor 124 may be configured to use a ML model based upon a plurality of training backscatter images. The ML model may comprise a U-Net convolutional neural network (CNN), a random forest, or a deep artificial neural network, for example. The processor 124 may be configured to control the spectral polarization for co-polarized and cross-polarized backscatter images. The spectral polarization filter 122 may comprise a rotatable spectral polarization filter.

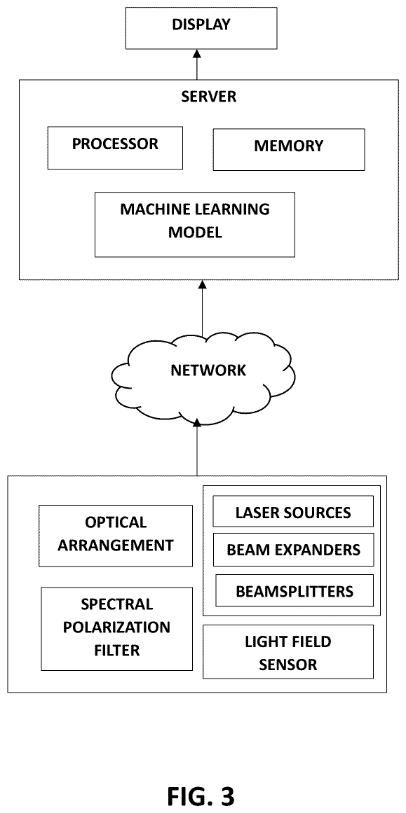

FIG. 3 depicts a block diagram 200 of the polarimetric light field imaging system 110. The system 110 includes a server 125 having at least one processor 124 and a memory 126 communicatively coupled to the at least one processor 124. As explained above, the processor 124 is configured to use a ML model 128 based upon a plurality of training backscatter images.

The processor 124 is configured to receive a plurality of backscatter images of the aerosol plume at different polarizations from the ALPS 105 through a network 130 (or directly). The processor 124 is configured to use the ML model 128 to determine a particle density and a particle size distribution of the aerosol plume through an analysis of the co- and cross polarized backscatter image fields. The results of the analysis can be output to a display 132.

The ALPS 105 includes the plurality of laser sources 112, 114 operating at different wavelengths that are configured to generate a plurality of laser beams. Beam expanders 116a, 116b expand the laser beams and direct them through non-polarizing beam splitting optics 118a, 118b to illuminate the visible target area through the optical arrangement 120. The optical arrangement 120 is downstream from the plurality of laser sources 112, 114 and is configured to transmit the plurality of laser beams toward the aerosol plume, and receive backscatter images therefrom. The ALPS 105 also includes a spectral polarization filter 122 downstream from the optical arrangement 120, and a light field sensor 106 downstream from the spectral polarization filter 122 that is configured to capture a plurality of backscatter images of the aerosol plume at different polarizations.

The processor(s) 124 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. In some embodiments, the processor 124 may be one or more physical processors, or one or more virtual (e.g., remotely located or cloud) processors. The processor 124 including multiple processor cores and/or multiple processors may provide functionality for parallel, simultaneous execution of instructions or for parallel, simultaneous execution of one instruction on more than one piece of data.

The network 130 may include one or more interfaces to enable the server 125 to access a computer network such as a Local Area Network (LAN), a Wide Area Network (WAN), a Personal Area Network (PAN), or the Internet through a variety of wired and/or wireless connections, including cellular connections.

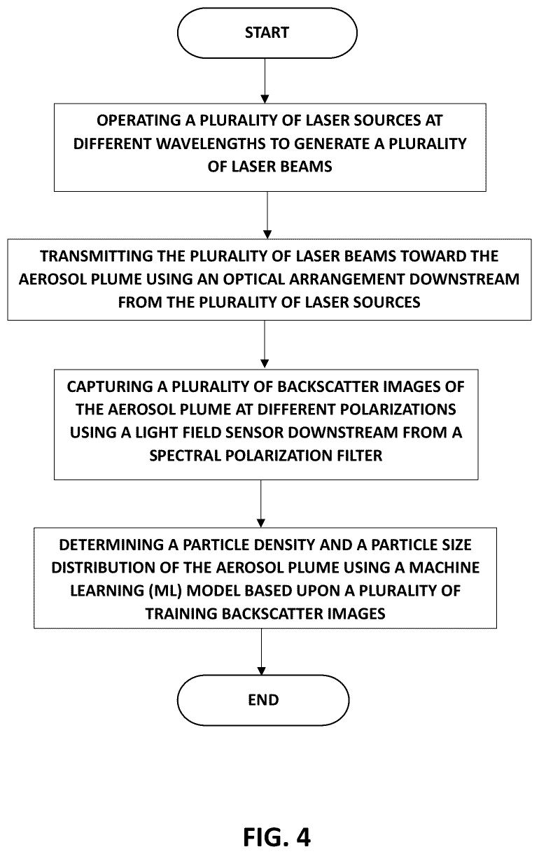

Referring now to the flowchart 300 in FIG. 4, and generally speaking, a method of polarimetric light field imaging is now described. From the start, at Block 302, the method includes operating a plurality of laser sources at different wavelengths to generate a plurality of laser beams, at Block 304. The method includes, at Block 306, transmitting the plurality of laser beams toward the aerosol plume using an optical arrangement downstream from the plurality of laser sources, and at 308, capturing a plurality of backscatter images of the aerosol plume at different polarizations using a light field sensor downstream from a spectral polarization filter.

The plurality of backscatter images may include co-polarized backscatter and cross-polarized backscatter where a hyperspectral backscatter image field may be generated for the co-polarized backscatter and the cross-polarized backscatter. As those of ordinary skill in the art can appreciate, the co- and cross-polarized backscatter could be collected and imaged in any order.

The method also includes, at Block 310, determining a particle density and a particle size distribution of the aerosol plume using a Machine Learning (ML) model, such as based upon a plurality of training backscatter images and an analysis of the co- and cross-polarized backscatter image fields. The method may also include performing measurements of both angular independence and wavelength shift of backscatter images using the light field sensor. The method ends at Block 312.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A polarimetric light field imaging system for an aerosol plume comprising:
a plurality of laser sources operating at different wavelengths and configured to generate a plurality of laser beams;
an optical arrangement downstream from the plurality of laser sources and configured to transmit the plurality of laser beams toward the aerosol plume, and receive backscatter images therefrom;
a spectral polarization filter downstream from the optical arrangement;
a light field sensor downstream from the spectral polarization filter and configured to capture a plurality of backscatter images of the aerosol plume at different polarizations; and
a processor coupled to the light field image sensor and configured to use a Machine Learning (ML) model to determine a particle density and a particle size distribution of the aerosol plume.

2. The system of claim 1, wherein the processor is configured to use the ML model based upon a plurality of training backscatter images.

3. The system of claim 1, wherein the ML model comprises a convolutional neural network (CNN).

4. The system of claim 1, wherein the ML model comprises a random forest.

5. The system of claim 1, wherein the ML model comprises a deep artificial neural network.

6. The system of claim 1, wherein the processor is configured to control the spectral polarization for co-polarized and cross-polarized backscatter images.

7. The system of claim 1, wherein the light field sensor is configured to perform hyperspectral wavelength discrimination.

8. The system of claim 1, wherein the light field sensor is configured to perform measurements of both angular independence and wavelength shift of backscatter images.

9. The system of claim 1, wherein the plurality of laser sources comprises a near infrared laser source and a shortwave infrared laser source.

10. The system of claim 1, wherein the spectral polarization filter comprises a rotatable spectral polarization filter.

11. A polarimetric light field imaging system for an aerosol plume comprising:
a plurality of laser sources configured to generate a plurality of laser beams;
an optical arrangement downstream from the plurality of laser sources and configured to transmit the plurality of laser beams toward the aerosol plume, and receive backscatter images therefrom;
a light field sensor coupled to the optical arrangement and configured to capture a plurality of backscatter images of the aerosol plume at different polarizations; and
a processor coupled to the light field image sensor and configured to use a Machine Learning (ML) model to determine a particle density and a particle size distribution of the aerosol plume based on measurements of both angular independence and wavelength shift of backscatter images.

12. The system of claim 11, wherein the processor is configured to use the ML model based upon a plurality of training backscatter images.

13. The system of claim 11, wherein the ML model comprises a convolutional neural network (CNN).

14. The system of claim 11, wherein the ML model comprises a random forest regression neural network.

15. The system of claim 11, wherein the ML model comprises a deep artificial neural network.

16. The system of claim 11, wherein the processor is configured to control a spectral polarization for co-polarized and cross-polarized backscatter images.

17. The system of claim 11, wherein the light field sensor is configured to perform hyperspectral wavelength discrimination.

18. A method of polarimetric light field imaging, the method comprising:
operating a plurality of laser sources at different wavelengths to generate a plurality of laser beams;
transmitting the plurality of laser beams toward the aerosol plume using an optical arrangement downstream from the plurality of laser sources;
capturing a plurality of backscatter images of the aerosol plume at different polarizations using a light field sensor downstream from a spectral polarization filter; and
determining a particle density and a particle size distribution of the aerosol plume using a Machine Learning (ML) model.

19. The method of claim 18, the ML model is based upon a plurality of training backscatter images.

20. The method of claim 18, wherein the ML model comprises a convolutional neural network (CNN), a random forest, or a deep artificial neural network.

21. The method of claim 18, further comprising performing measurements of both angular independence and wavelength shift of backscatter images using the light field sensor.
